(19) United States
(12) Patent Application Publication
(10) Pub. No.: US 2013/0234059 A1
(43) Pub. Date: Sep. 12, 2013

(54) Haloalkene Complexes

(71) Applicant: Bob Lee Davis, Roseburg, OR (US)

(72) Inventor: Bob Lee Davis, Roseburg, OR (US)

(21) Appl. No.: 13/731,608

(22) Filed: Dec. 31, 2012

Related U.S. Application Data
(60) Provisional application No. 61/608,954, filed on Mar. 9, 2012.

(51) Int. Cl. C09K 5/04

(52) U.S. Cl. CPC C09K 5/041
USPC 252/67

(57) ABSTRACT

Compositions comprising an activated oil blend are provided. Also provided are compositions comprising a halo-alkene complex can be used as a refrigerant. The compositions can increase the energy efficiency and reduces leakage rates of refrigeration systems. Some compositions comprise at least 0.1 wt % of an oleic oil fatty acid, 0.1 wt % of a linoleic oil fatty acid, and at least 98 wt % of r-134a. Some compositions comprise an oil blend comprising an oleic acid to linoleic acid ratio of approximately 60:1. At least some of the r-134a can be complexed with at least one of the organic oil fatty acids.

This application claims the benefit of priority to U.S. provisional application No. 61/608,954, filed on Mar. 9, 2012. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is haloalkene complexes, and more specifically haloalkene complexes for use as a refrigerant composition.

### BACKGROUND

The background description includes information that may be useful in understanding the present invention. It is not an admission that any of the information provided herein is prior art or relevant to the presently claimed invention, or that any publication specifically or implicitly referenced is prior art.

Existing commercially available refrigerant compositions generally comprise specific chlorofluorocarbons (CFCs), hydrochlorofluorocarbons (HCFCs), and hydrofluorocarbons (HFCs), and can have some uses beyond refrigeration.

For example, U.S. Patent Application Publication No. 2011/0012052 to Van Horn et al. teaches a mixture of specific alkenes with HFCs, for use as a heat transfer composition. However, Van Horn's mixture is apparently not a complex. The alkene and HFC are described by Van Horn as being miscible, which means they mix in all proportions. There is no indication that Van Horn's mixture is sufficiently activated to be complexed through Van der Waals forces.

U.S. Patent Application Publication No. 2007/0092545 to Bale teaches an aerosol coolant spray comprising an essential oil, HFC, and diluent material, for killing and removing ticks. However, Bale also fails to teach a complex formed via activation of the mixture. Moreover, Van Horn and Bale each fail to address the global warming concerns associated with refrigerant compositions.

The last few decades have seen a growing emphasis on reducing the global warming impacts caused by refrigerants and refrigerant compositions. Various studies have been conducted to address the pitfalls of existing refrigerants and refrigeration systems (See e.g., “Real Zero—Reducing refrigerant emissions & leakage—feedback from the IOR Project” by Cowan et al. Available at http://www.epa.gov/greenchill/downloads/IOR_ReducingRefrigerantEmissions.pdf). Two ways in which global warming impacts can be reduced is through (a) increases in energy efficiency of heating and cooling units (e.g., ΔT/Pᵢₙ, wherein ΔT represents the change in temperature (T), and Pᵢₙ represents the electric power represented in watts (W)) and (b) decreases in leak rates of refrigerants.

Currently, HVAC (heating, ventilation, and air conditioning) and refrigeration accounts for much of the worldwide energy consumption. Unfortunately, it has yet to be appreciated that certain complexes can be used as a refrigerant to increase energy efficiency or decrease leak rates, thereby reducing the global warming impact caused by existing refrigerants. Thus, there is still a need for improved complexes.

### SUMMARY OF THE INVENTION

The inventive subject matter provides compositions, apparatus, systems and methods of haloalkene complexes that can be used for refrigeration, heating, air conditioning, or any other commercially suitable uses.

As used herein, the term “haloalkene complex” means two or more molecules held together through Van der Waals forces (also known as Van der Waals interactions), wherein at least one of the molecules is a haloalkene, or a haloalkane and an alkene are complexed via Van der Waals forces. Preferably, the complex is formed upon activation, in a controlled environment, of at least one of the molecules. It is contemplated that a haloalkene complex's molecular arrangement can change when pressure is increased or decreased.

In one aspect of the inventive subject matter, a composition comprises a polar heat transfer fluid, such as a hydrofluorocarbon, complexed with an organic oil fatty acid. As used herein, the term “organic oil fatty acid” can include a fatty acid of an organic oil or a fatty acid of an organic oil blend. Preferably, the heat transfer fluid is complexed with at least some of the organic oil fatty acid through Van der Waals forces, upon activation of the fatty acid under heat and pressure.

A polar heat transfer fluid can be complexed with at least 1, 5, or even 10 or more % of a first organic oil of a composition. This complexing can exist between polar heat transfer fluid molecules and fatty acids of the oil blend via Van der Waals forces. In some embodiments, the fatty acid molecules of an oil blend are activated in a closed vessel under heat and pressure. In some embodiments, the composition made by this complexing can comprise approximately 95-99 weight percent (wt %) of the polar heat transfer fluid, and approximately 1-5 wt % of the oil blend. Thus, the composition can comprise a polar heat transfer fluid to oil blend ratio of 1:99 or 5:95, or any ratio in between. Moreover, all commercially suitable ratios of polar heat transfer fluid to oil blend is contemplated, including for example: 0.1:99.9; 10:90; 25:75; 50:50; 75:25; or 99:1, among others.

It should be appreciated that the oil complexes contemplated herein include food and other natural oils, as well as synthetic oils.

As used herein the term “fatty acid” refers to a substituted or non-substituted, saturated or unsaturated, carboxylic acid with a long aliphatic tail (chain). This would include, for example, a fatty acid ester, a fatty acid having no double bonds, and a fatty acid having multiple double bonds. As used herein a simple fatty acid is a non-substituted, saturated or unsaturated fatty acid. Oleic acid and linoleic acid are examples of simple fatty acids. It is contemplated that the inventive concepts herein, including those embodied in the originally filed claims, could apply to the more general type of fatty acid, and to simple fatty acids.

In some aspects of the inventive subject matter, compositions at least 0.1 wt %, 1 wt %, 2 wt %, at least 3 wt %, at least 4 wt %, at least 5 wt %, at least 10 wt %, at least 15 wt %, at least 20 wt %, at least 50 wt %, or at least 95 wt % of the heat transfer fluid therein is complexed with an organic oil fatty acid. A heat transfer fluid can be complexed with at least 1%, at least 5%, at least 10%, at least 25%, at least 50%, or at least 80% of the fatty acid composing the composition.

Each of the organic oils or the oil blend as a whole can compose at least 0.1 wt %, at least 1 wt %, at least 2.5 wt %, at least 5 wt %, at least 10 wt %, at least 15 wt %, at least 20 wt %, at least 25 wt %, at least 50 wt %, or at least 95 wt % or more of the composition. A heat transfer fluid can be complexed with at least 1%, at least 5%, at least 10%, at least 25%, at least 50%, or at least 80% of the organic oil(s) composing the composition.

Also in some embodiments, a first fatty acid (e.g., linoleic acid or oleic acid, etc.) can compose at least 0.1 wt %, at least 1 wt %, at least 2.5 wt %, at least 5 wt %, at least 10 wt %, at least 15 wt %, at least 20 wt %, or at least 25 wt % of the composition. In less preferred embodiments, the first fatty acid can compose less than 0.1 wt % of the composition.

Contemplated compositions can comprise two or more different organic oils, and each organic oil can comprise one or more fatty acids having one, two, three, or even more carbon-to-carbon double bonds. In some embodiments, the fatty acid(s) compose at least one food oil of an oil blend, including for example, walnut, canola, sunflower or almond oil.

The polar heat transfer fluid can comprise any commercially suitable heat transfer fluid, but is preferably a hydrofluorocarbon, and even more preferably a halo-ethane such as a tetrafluoroethane.

At least one of the organic oil(s), the fatty acid(s) and the polar heat transfer fluid can be activated in any suitable apparatus, including for example, a tube or pipe or closed vessel apparatus comprising at least one of a copper, nickel, palladium, zinc, platinum, rhodium, iridium, or an alloy thereof, or a copper mesh, a steel mesh, or Nylon scrub pads. It is also contemplated that the activation can occur under heat and pressure. As used herein, the term “under heat and pressure” means at least 15° C., and at least 1.25 atmosphere (atm). Other contemplated heating temperatures include at least any of 20° C., 30° C., 50° C., 100° C., 150° C., or even 200° C. or more. Other contemplated pressures include at least any of 1.5 atm, 5 atm, 10 atm, 25 atm, 100 atm, or even 150 or more atm. Where an oil blend is activated (e.g., in a closed vessel having a catalyst), it is contemplated that the oil blend can be a composition of the inventive subject matter, even without the addition of a polar heat transfer fluid.

In one aspect, a small amount of polar heat transfer fluid can be added before or during activation of an oil blend. It is also contemplated that a small amount of polar heat transfer fluid can be added shortly after activation (e.g., within one hour, within two hours, etc.). Still further, the activated oil blend and small amount of polar heat transfer fluid can then be injected into a large quantity of the polar heat transfer fluid for further complexing.

It is contemplated that a composition of the inventive subject matter can have a superior compressibility factor than existing refrigerants and refrigerant compositions.

In some embodiments of the inventive subject matter, 0.1 to 95 wt % of 1,1,1,2-tetrafluoroethane (also known as r-134a) is mixed with 27 to 99.9 wt % of one or more organic oil(s), and at least 0.1% of the r-134a is complexed with some of the organic oil(s) via Van der Waals forces (e.g., the r-134a interacts with a hydrogen of a carbonyl group of a fatty acid of the organic oil, or a carbon-to-carbon double bond of the organic oil). Without wishing to be limited to any particular theory or mechanism of action, it is contemplated that an absorptive process can occur wherein the r-134a is complexed to the fatty acid(s) of the organic oil(s) via a Van der Waals force attraction to the carbon-to-carbon double bonds, and that such complexing can tend to inhibit oxidation or other deterioration of the fatty acid.

The double carbon bond is a relatively stable zone, where the atoms on either side generally do not spin as rapidly about as with comparable singly bonded carbons. This is borne out in experimental data, where the complexing of an r-134a molecule with a double carbon bond of a fatty acid can create a unique signature that is detectable with H-NMR and x-ray diffraction. While not wishing to be limited by any particular mechanism of action or theory of operation, in this or other recitations of theory herein, it appears that some type of significant complexing is taking place when the activated oil blend is dissolved in r-134a.

In some embodiments, the r-134a can be mixed with 27 to 99.9 wt % of at least two different organic oils. It is contemplated that the first and second organic oils can be activated in a tubing apparatus under a heat of 15 to 200 or more ° C. and a pressure of 1 to 150 or more atm for a period of time between one minute and twenty-four or more hours. This activation can occur prior to mixing and/or complexing with the r-134a, or can occur with r-134a already mixed with the first and second organic oils (e.g., the oils and at least some of the r-134a can be activated and complexed within the apparatus). It is also contemplated that the oils can be activated first, and mixed/complexed with r-134a at a later time (ranging from immediately after activation to days, months, or even years later).

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic illustrating the production of a composition of the inventive subject matter.

FIG. 2A shows the chemical structure of a fatty acid molecule (oleic acid).

FIG. 2B is a front perspective view of a r-134a molecule complexed with an fatty acid molecule (oleic acid).

FIG. 2C is a top perspective view of a r-134a molecule complexed with a fatty acid molecule (oleic acid).

FIG. 3 is a schematic of a r-134a molecule.

FIG. 4 is a chart showing a side by side comparison of 3 ton units running continuously using Bluon™ TdX versus r-22 refrigerants.

FIG. 5 is a chart showing a side by side comparison of 3 ton units running continuously using Bluon™ TdX versus r-410a refrigerants.

FIG. 6 is a schematic of a typical refrigeration cycle.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

It should be noted that while the below description sometimes focuses on a B1™ oil blend, and Bluon™ tdX™ (B1 oil blend injected into a large quantity of r-134a), the inventive subject matter should be interpreted to include other combinations of halo-alkene complexes comprising a heat transfer fluid and a fatty acid.

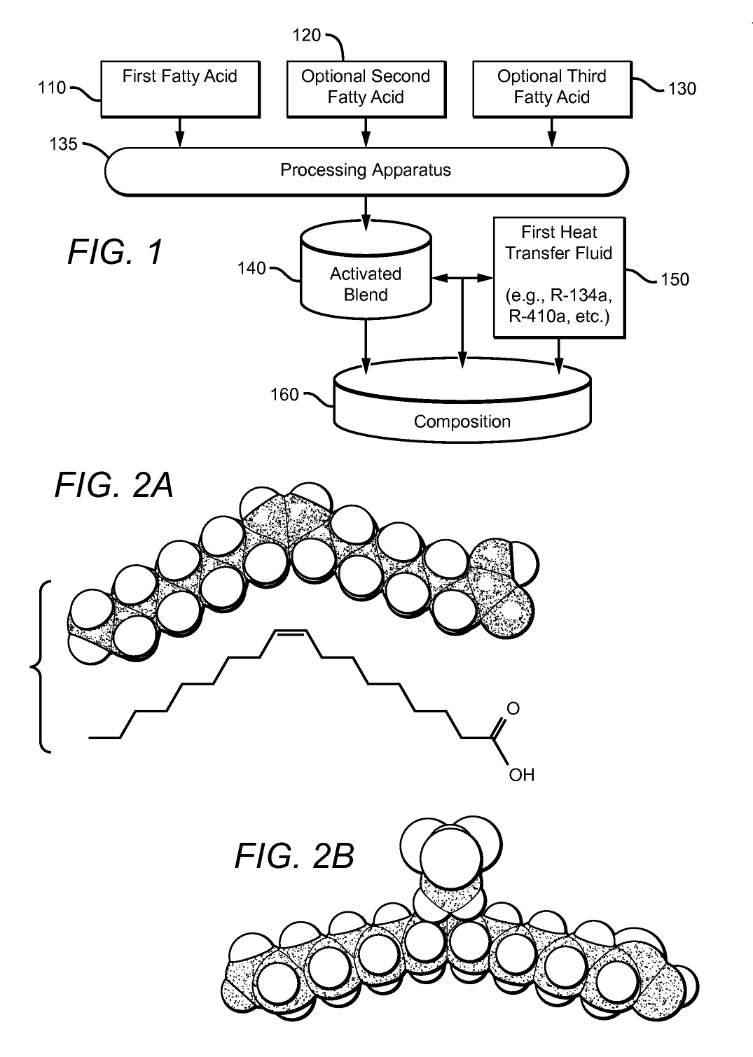

FIG. 1 is a schematic illustrating how a composition of the inventive subject matter could be made. First, second and third fatty acids (110, 120, 130) composing first, second and third organic oils are combined and processed under heat and pressure, in processing apparatus 135 having a controlled environment, to form an activated blend 140 of organic oils.

The controlled environment under which one or more of the fatty acids are processed can include, among other things, predetermined materials, temperatures, pressures, or times. One example of a predetermined material can comprise material that the processing apparatus composes (e.g., copper, iron, steel, wood, plastic, etc.) or a catalyst inserted into the processing apparatus. A predetermined temperature or pressure can be the temperature/pressure or range of temperatures/pressures that the organic oil(s) or fatty acid(s) are exposed to during processing. A predetermined time can be the length of time the organic oil(s) or fatty acid(s) are processed, the length of time the organic oil(s) or fatty acid(s) are processed under a given temperature, the length of time the organic oil(s) or fatty acid(s) are processed under a given pressure, and so forth.

Examples of fatty acids include for example, oleic acid, linoleic acid, linolenic acid, myristoleic acid, palmitoleic acid, sapienic acid, elaidic acid, vaccenic acid, arachidonic acid, eicosapentaenoic acid, erucic acid, docosahexaenoic acid, and palmitic acid, linolaidic acid, and α-linolenic acid. In some embodiments, unsaturated fatty acids are preferred. Each acid can be derived from any suitable source, including for example, an organic oil (e.g., a plant oil, food oil, etc.). As used herein, an “organic oil” is any oil produced by plants, animals, and other organisms through natural metabolic processes other than crude oil or petroleum-based oils. Contemplated food oils include walnut oil, almond oil, canola oil, beech nut oil, coconut oil, cottonseed oil, olive oil, palm oil, peanut oil, safflower oil, sesame oil, soybean oil, sunflower oil, cashew oil, hazelnut oil, macadamia oil, pecan oil, pine nut oil, pistachio oil, grapefruit seed oil, lemon oil, orange oil, pumpkin seed oil, watermelon seed oil, or any other suitable food based oil. In is contemplated that a composition having only a single type of fatty acid (or predominantly a single type of fatty acid) can comprise a higher or lower wt % of the fatty acid (or the organic oil(s) comprising the fatty acid) depending on the type used. For example, a composition having only (or predominantly) oleic acid can have less than, twice as many, or even three times or more fatty acids than a composition having only (or predominantly) linoleic acid, or some other acid.

It should also be noted that it may be possible to manufacture a wide variety of synthetic oils that can be activated and complexed with a polar heat transfer agent. Such oils could have an odd number of carbons, an even number of carbons, no double carbon bonds, two or more double bonds, etc.).

Once the fatty acid (or oil comprising the fatty acid) is processed and activated, the activated blend 140 can be infused, injected into, or otherwise combined with first heat transfer fluid 150 to produce composition 160 comprising a halo-alkene complex having Van der Waals interactions. As discussed above, a small amount of the heat transfer fluid could have been mixed with the fatty acids in the processing apparatus, and complexed therein upon activation of the fatty acids.

As used herein, the term “Van der Waals force” or “Van der Waals interaction” means the sum of the attractive or repulsive forces between molecules (or between parts of the same molecule), other than those due to covalent bonds, or the electrostatic interaction of ions with one another or with neutral molecules. It is true that some authorities use the term more narrowly to exclude hydrogen bonding, but as used herein the term includes hydrogen bonding, forces between two permanent dipoles (Keesom force), forces between a permanent dipole and a corresponding induced dipole (Debye force), and forces between two instantaneously induced dipoles (London dispersion force).

All commercially suitable heat transfer fluids are contemplated, including for example, methane-based (r-(000-099)) refrigerants, ethane-based (r-(100-199)) refrigerants, propane-based (r-(200-299)) refrigerants, cyclic organic (r-(300-399)) refrigerants, zeotropes (r-(400-499)), azeotropes (r-(500-599)), organic (r-(600-699)) refrigerants, inorganic (r-(700-709)) refrigerants, and unsaturated organic (r-(1000-1099)) refrigerants.

It is contemplated that a composition of the inventive subject matter can be used in an existing refrigeration system that is compatible with r-134a, r-410 or r-22, or some other refrigerants. However, some modifications, preferably minor, can be required (e.g., a small part change, addition, etc.). An inferior refrigerant can be completely removed from the system, and the system can be recharged with a composition of the inventive subject matter. Moreover, a composition of the inventive subject matter can be added to a system without complete removal of a prior refrigerant from the system. This is due to the fact that the compositions appears to be more energy efficient and self-sealing than existing refrigerants, even when combined with one or more contaminants (e.g., an inferior refrigerant or refrigerant composition, such as r-134a, r-410, r-22, etc.).

Moreover, a composition of the inventive subject matter could be used in a novel unit comprising a different ratio of compressor size to coil size. For example, as compared to an existing refrigeration unit having a compressor size to coil size ratio of X:Y, a new unit can have a ratio of X−Z:Y, X+Z:Y, X:Y−W, or X:Y+W, wherein Z is at least 10%, 20%, 30%, 50%, or even 75% or more of X, and wherein W is at least 10%, 20%, 30%, 50%, or even 75% or more of Y. As another example, a new unit can have a greater number of, or a different configuration of, coils.

One possible composition of the inventive subject matter is the novel Bluon™ tdX™. Bluon TdX comprises a mixture of approximately 95-99 wt % of 1,1,1,2-Tetrafluoroethane (i.e., r-134a) at least partially complexed with approximately 1-5 wt % of B1™, a non-toxic oil blend comprising one or more organic oils, wherein the oil blend has an oleic acid to linoleic acid ratio of between 70:30 and 50:50, and preferably approximately 60:40 wt %. The organic oils of B1 can include one or more of a canola oil, a walnut oil, an almond oil, and a sunflower oil, among others (“the B1 oils”). One contemplated B1 blend comprises walnut, almond and canola oils (“CAW B1 blend”). Another contemplated B1 blend comprises canola and sunflower oil (“CS B1 blend”), preferably at an approximate ratio of between 5:1 and 2:1 (e.g., 3:1). Yet another contemplated B1 blend comprises walnut, almond and canola oils, and a small amount of r-134a.

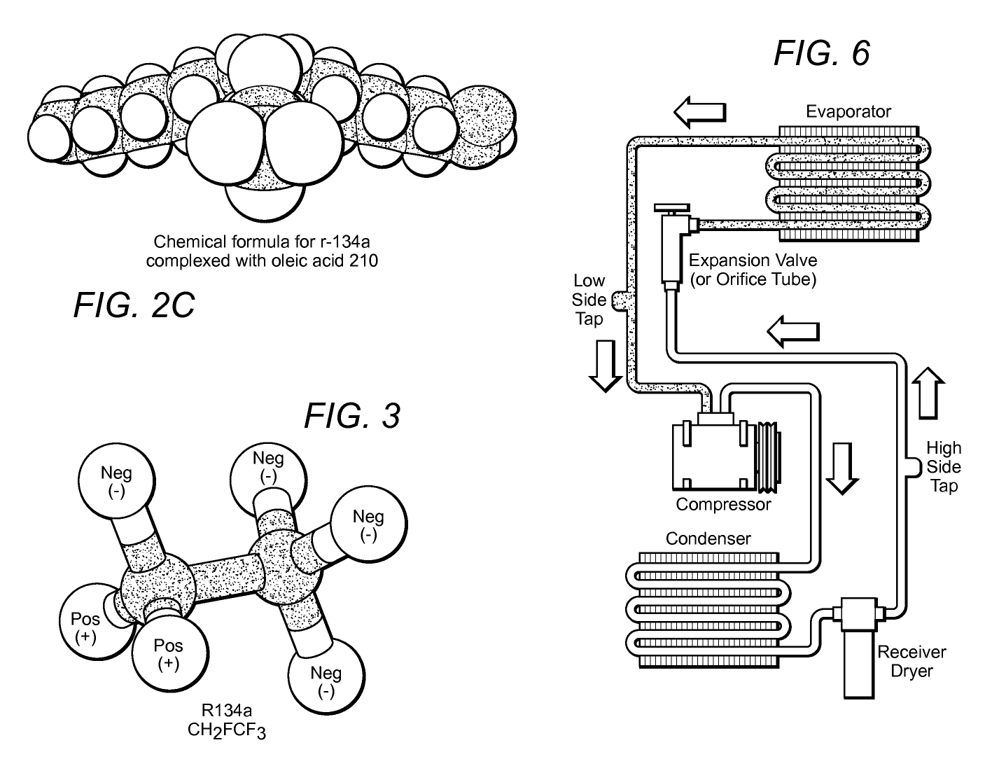

A perspective view of a fatty acid molecule composing a preferred oil blend of the inventive subject matter (e.g., B1oil blend) is shown in FIG. 2A. Perspectives views of a r-134a molecule complexed with a fatty acid molecule is shown in FIGS. 2B-2C.

It appears that the complexing occurs in two steps. The first step occurs when the two positively charged hydrogen atoms of r-134 Van der Waals interact with an exposed negatively charged double carbon bond, to form a shared triad/quad. This is a relatively weak form of Van der Waals interaction and relies on surface reaction chemistry to form. This relatively weak interaction could explain an observed effervescence.

A second stage bonding apparently occurs when the extremely negatively charged fluoride attached to the same carbon of the r-134a with the two hydrogens, then bonds to the two positively charged hydrogen atoms which are attached to the two carbons of the double carbon bond. A synergistic effects of the two oppositely charged/aligned triads can have an overall strengthening effect and could lock in this multi-interaction.

As the presence of r-134a bound to the B1 oils increases, the viscosity of Bluon TdX can also increase. As discussed above, any commercially suitable refrigerant(s) can be infused with any suitable oil or oil blend comprising a fatty acid to produce a composition of the inventive subject matter. Thus, the activated oils and specific complexes discussed in detail herein are only some of the possible compositions of the inventive subject matter.

On the hand, R-134a has been shown experimentally to provide the most significant improvement in refrigeration efficiency when mixed with the oils of a B1 oil blend, possibly due to its highly polar nature as compared with other refrigerants. In particular, a mixture comprising approximately 95-99 wt % of r-134a and approximately 1-5 wt % of B1 (which can also include approximately 50% of an oleic acid and 33% of a linoleic acid) was found to be very efficient.

The B1 oils of one possible B1 blend comprising walnut oil, almond oil, and canola oil, the CAW blend, are quite similar in chemical composition, as shown in Tables 1A-B (below). The Oleic acid accounts for approximately 50% of the “fatty acids” in the B1 blend (comprising precursor/feedstock oils) and are an Alkene with an 18 long carbon chain. Oleic acid has one double carbon bond. Linoleic acid accounts for around 34% of the fatty acids in the blend and is also 18 carbons long, with two double carbon bonds. Linolenic acid is around 9% of the fatty acids in the blend and is 18 carbons long, with three double carbon bonds. Palmitic acid is around 5% of the fatty acids in the blend and is 16 carbons long.

Feedstock Oil Ratios

| | Walnut Oil | Almond Oil | Canola Oil |
|---|---|---|---|
| Oleic Acid | 28% | 69% | 61% |
| Linoleic Acid | 51% | 17% | 21% |
| Linolenic Acid | 5% | | 9% |
| Palmic Acid | 11% | 7% | 4% |

Blend for B1

| | | Weighted by | | |
|---|---|---|---|---|
| | Total | Bonding Sites | Carbon # | Carbon Type |
| Oleic Acid | 49.30% | 34.50% | 18C | Alkene |
| Linoleic Acid | 33.30% | 45.00% | 18C | Alkene |
| Linolenic Acid | 8.67% | 18.30% | 18C | Alkene |
| Palmic Acid | 5.30% | 0.00% | 16C | Alkane |

These food oils predominantly consist of relatively long-chain carbon molecules or fatty acids bonded to a glycerol. Fatty acids in free form have a carboxyl group (COOH) at the first (Alpha) carbon on the carbon chain, making them carboxylic acids. In plants, most fatty acids are bonded in triplets to a glycerol molecule to form a triglyceride. A triglyceride can have different types of oils in various arrangements attached to it. Oleic fatty acids in some plants tend to be mostly bonded in di-glycerides, especially those derived from rapeseed oil (Canola Oil). Mono-glycerides are only present in significant amounts in a few plants, such as peanuts. In common practice, the tri, di or mono-glycerides are ignored and only the fatty acid or “oil” content is listed. This is due to the glyceride fatty acid bond being esterified before most kinds of chemical testing, allowing for the various fractions of fatty acids to be accurately measured.

One important discovery from an H-NMR application was the presence of complexed R-134a to the Bluon TdX oils (e.g., of the B1 oil blend) by inter-molecular hydrogen bonding and Van der Waals forces. The chemical complexing of the r-134a to the oils leaves a detectable signature, and is relatively stable and remains in tact even after days in a depressurized state. Surprisingly, the amount of tightly complexed r-134a to the Bluon TdX oils apparently increased over time when used in an air conditioning system, thereby inhibiting degradation of the oils.

A catalyst can be used to cause a reaction between the r-134a and a fatty acid. When r-134a is bubbled intensively through the oil, it is possible that no reaction occurs, even at 300 degrees F. and over long periods of time. This is likely due to the rapid spinning along the axis of the carbon to carbon single bonds on both the r-134a and fatty acid molecules. In the liquid oil, the singly bonded carbons can spin relative to each other many thousands of times a second. In the r-134a gas, the relative spin rate can be magnitudes faster, and it is likely that the two molecules simply bounce off each other.

When a catalyst is present above the sparge, a rapid reaction can occur, even at room temperature. Pressure in the reaction chamber rapidly drops while temperature rises, thereby evidencing an exothermic reaction. The type of chemistry occurring includes surface reaction chemistry. When inert gasses such as Nitrogen were run through the chamber with the catalysts, no reaction was observed.

When a fatty acid is at least partially immobilized on copper or other activation surface through Van der Waals forces, the carbon to carbon single bond spinning is vastly reduced. This reduction is also true for the r-134a when it reacts with the surface. This allows the Keeson and Debye forces to predominate, and Van der Waals absorption of the r-134a onto the oil occurs. This reaction occurs in an extremely short interval of time, before the product is swept off the surface into the mass of the oil blend. The source of heat observed during the reaction is likely from the heat released due to the phase change of the r-134a from a gas to a liquid.

In opening the reactor chamber and passing a copper mesh through the freshly absorbed complexes, effervescence can be observed. However, this phenomenon goes away over time without evidence of degassing into the reactor chamber. It appears that the initial absorption Van der Waals interaction/complexing changes to a different stronger Van der Waals complexing over time. This was evidenced by a strong r-134a signature even in Bluon TdX that was weeks old and suspending over boiling water in test tubes for hours. Nor was a weakening of the r-134a signature observed when the Bluon TdX was exposed to the atmosphere over a long period. No significant degassing was observed after approximately two weeks.

Over time the measurable signature of the r-134a in the oil measurably increased when used in an air conditioning unit. The signature appears to increase along with the repeated mixing of the oil and r-134a through normal machine operations. A noticeable increase in viscosity and change in color can also occur with an increasing r-134a signature. An end of r-134a that sticks out can apparently form ever shifting double hydrogen bonds with the numerous hydrogen atoms of other oil molecules, which increases viscosity. The complexing apparently does not remove or replace any atoms on either the r-134a or fatty acid molecules, as the signatures of both molecules remained.

In some testing, prior to use in a refrigeration system, Bluon TdX shows a slight presence of two quartets at 4.7 and 4.58 in the H-NMR, indicating r-134a bonding. Bluon TdX that was used for 120 days showed much more pronounced quartets at these sites. This shows more r-134a is binding to the oils over time, indicating that Bluon TdX grows even better with use, at least up to a certain point.

The molecular Van der Waals behavior of these new halo-alkenes also has been shown to change over time. The halo-alkene Bluon TdX recovered from unused samples is a clear yellow viscous liquid. This clear yellow color indicates whatever bonded water existed in the CAW B1 blend, has been expunged. The Bluon TdX liquid is also more viscous than the CAW B1, flowing at a noticeably slower rate. The blue-green color of the 120 day used Bluon TdX, indicates that as more r-134a binds to the oils, intra-molecular (resonant frequencies) rise, along with viscosity. In testing of the fresh Bluon TdX, the oil was very hydrophobic and would not mix with any amount of water.

A composition of the inventive subject matter can produce the same amount of heating or cooling in a system using less than 90%, less than 75%, less than 50%, or even less than 33% of conventional refrigerants (e.g., r-134a, r-410, r-22, etc.). For example, sensor arrays and data streams recorded show that Bluon TdX can produce the same amount of cooling in a system for somewhere between 35% and 60% of the wattage compared to some conventional refrigerants. A composition of the inventive subject matter can also keep a space colder or hotter for longer periods of time than conventional refrigerants. For example, it has been found that Bluon TdX can keep a space colder or hotter for longer periods of time than existing refrigerants or refrigerant compositions. Thus, a system utilizing Bluon TdX or other composition of the inventive subject matter can provide the same cooling or heating as a system utilizing r-410, while running for approximately 10-30 minutes less per hour. Moreover, compositions of the inventive subject matter (e.g., Bluon TdX) charged refrigeration units and systems can produce significantly less condensation off evaporate coils. For example, over an eight hour test run of two air conditioning systems, an r-410a charged system had an evaporator coil temperature of 55.2 degrees F. and condensate of 5.75 gallons, while a Bluon TdX charged system had an evaporator coil temperature of 51.4 degrees F. and condensate of 1 gallon. This phenomenon of reduced condensation was observed in each Bluon TdX charged air conditioning system. This highly unusual electron resonant effect appears to contribute in making Bluon TdX a novel and very unique halo-alkene. The drop in condensation is a contributing factor to the greatly increased efficiency of Bluon TdX charged systems.

R-134a is unique among the fluorocarbon refrigerants, in that it is also used as a solvent in the pharmaceutical industry. This solvent ability is due to the polar nature of its molecule as shown in FIG. 3. One side of the molecule has the negatively charged fluoride atoms, while the other side has the positively charged hydrogen. The polar nature of water also makes it an excellent solvent.

It should also be noted that Debye or other Van der Waals can be quite strong between or among long chain oils (triglycerides). This attraction is why these oils are liquid over such a wide range of temperatures and have such a high vaporization point (boiling point). These characteristics are useful for frying and evidently refrigeration.

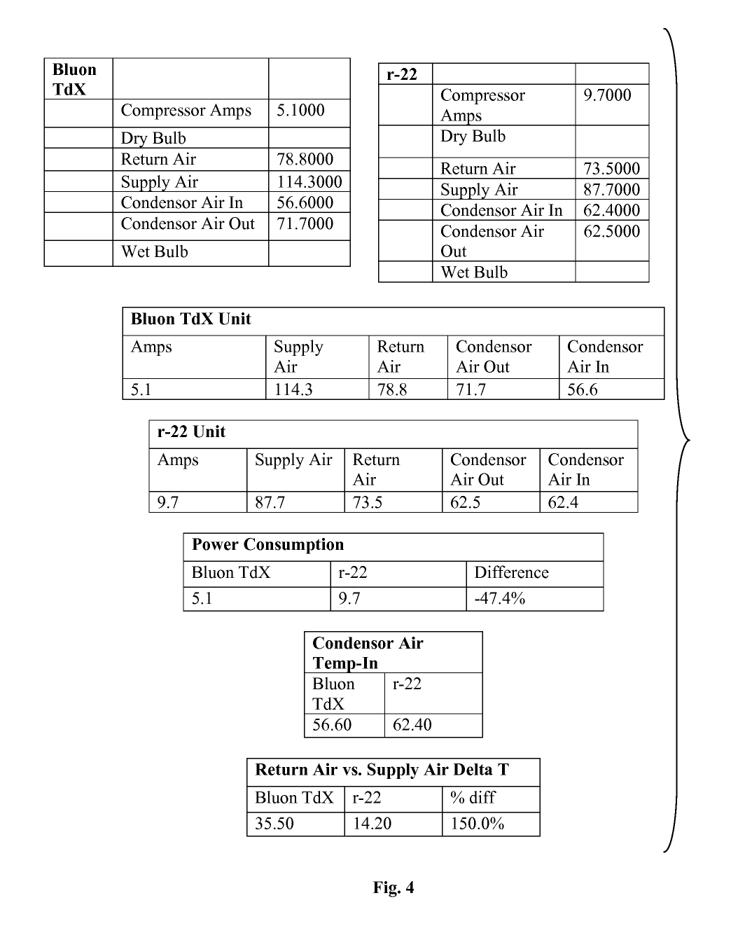

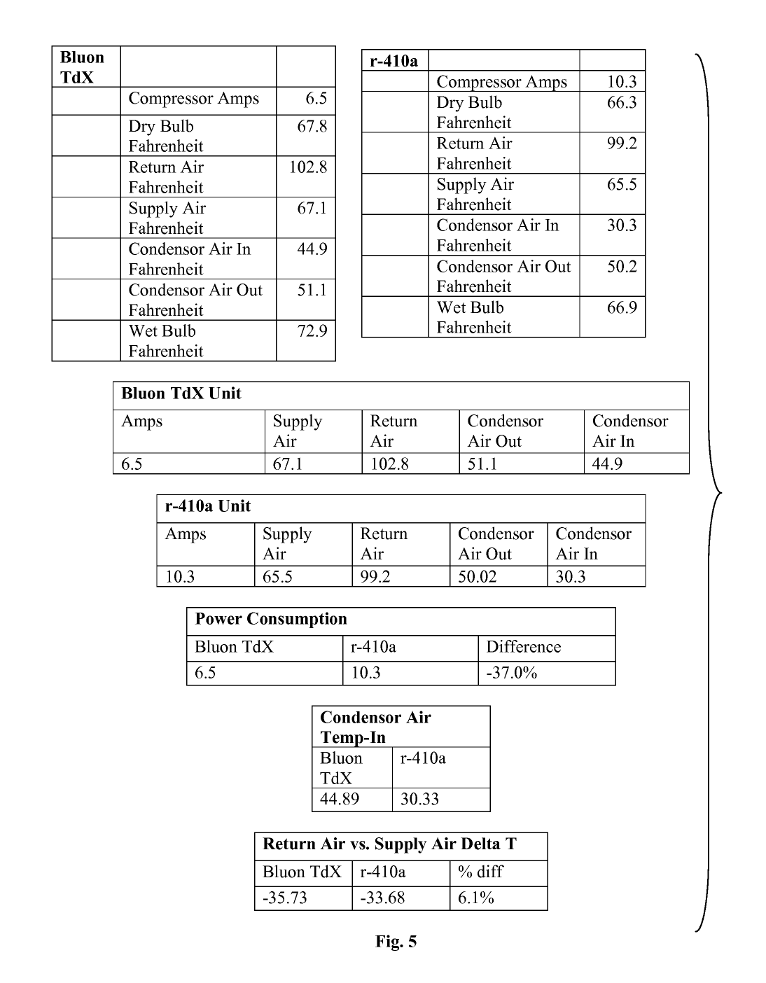

FIG. 4 is a series of charts representing a side by side comparison of two 3 ton units, one running continuously using Bluon TdX, and the other running continuously r-22 refrigerant. The Bluon TdX comprises a CAW B1 oil blend. FIG. 5 is a series of charts representing a side by side comparison of two 3 ton units, one running continuously using Bluon TdX, and the other running continuously r-410a refrigerant. Again, the Bluon TdX comprises a CAW B1 oil blend.

As shown in FIG. 6, air conditioning systems generally utilize a refrigerant cycle having two main parts, the condenser cycle and the evaporator cycle. The following description is of a standard air conditioner system. The condenser cycle starts at the compressor, where the warmed gas from the evaporator cycle is compressed back into a semi-liquid. This semi-liquid is then pumped through condenser coils, where a fan removes the heat into the outer environment and the gas becomes fully liquefied. This liquefied cooled fluid then flows to the expansion valve, where it changes from a liquid into a gas and adiabatically cools. This cooled gas then flows into the evaporator coils, were a fan blows cooled air into the controlled environment and the gas is warmed.

Increased pumping efficiency in the compressor, is likely the most significant cause of the increased efficiencies of Bluon TdX and other compositions of the inventive subject matter. One reason for this increased efficiency is the highly viscous characteristics of the oil blends of the inventive subject matter (e.g., CAW B1, CS B1, etc.). The oil blends (and thus the Bluon TdX) can increase the sealing around the piston in a reciprocal pump, the spinning blades in a centrifugal pump or internals of a scroll pump, over commonly used mineral oils. Another minor reason, is it takes less energy to pump an incompressible liquid, than it takes to pump a compressible gas. The oil blend in the Bluon TdX is always or almost always going to be liquid, as the temperature of the oils will never come remotely close to their vaporization points. Some atomization likely occurs at the expansion valve, but will quickly re-liquefy onto the internal surface of the evaporator. The r-134a is driven into a liquid at the compressor and also likely dissolves more rapidly into the Bluon TdX oil blend, than a mineral oil. At this higher pressure, Van der Waals forces would likely complex the r-134a to the oils, in much the same manner the oils are bonded to each other in a liquid state.

After leaving the condenser, the cooled liquid reaches the expansion value and the r-134a can begin its transition into a gas. The phase transition can be driven to completion in the evaporator coils. This is also likely where a secondary cause of increased efficiencies of compositions of the inventive subject matter (e.g., Bluon TdX) is found. It is a unique physical process likely dependent on r-134a's polar interaction with the structure of the particular oils. Some preparatory discussion is necessary to delve into this unique process.

Polarity, solvent ability and heat capacity in molecules are closely related. Due to the unique structure of r-134a and the C═C/C═O binding sites on the mixed oils, as well as Van der Waals dispersion forces, a sharing of heat capacity occurs during the fully liquid phase. In some preferred oil mixtures, the ratio of oleic acid to linoleic acid is approximately 3:2. These two acids have quite different heat capacities despite their close chemical structure of 18 carbon units. This is due to the number of double (C═C) carbon bonds. Oleic acid has a heat capacity of 2.88 kJ/(kg·K) (kilojoules perKilogramsK), to linoleic acid's heat capacity of 0.37 kJ/(kg·K).

R-134a is only two carbon units long and its heat capacity is 1.34 kJ/(kg·K). Although smaller than Oleic acid, the key to r-134's usefulness is its heat of vaporization at approximately −15.3° F. (boiling point) at atmospheric pressure. It can transform from a liquid to a gas phase around the temperatures useful for cooling, allowing it to efficiently shed heat. This is a key to any good refrigerant. The fatty acid oils cannot do this, due to their extremely high heat of vaporization. Linolenic acid has the lowest heat of vaporization at 450° F.

On the other hand, these organic oil fatty acids can generally have melting points around the temperatures that air conditioning unit evaporators operate. Oleic acid has a melting point of approximately 55° F., while that of linoleic acid is approximately 23° F. and linolenic acid is at approximately 12° F. For r-134a, the relevant value is heat of vaporization at approximately −15.3° F. The expansion valves on standard air conditioner units are adjusted to take the evaporator toward the freezing point of water, but not so cold that ice forms on the outer surface of the evaporator. Therefore, the r-134a is not going to reach its full potential cooling, but will vaporize above the melting points of the high acid oils. The oils in the Bluon TdX are generally almost always or always going to be liquid, although some atomization likely occurs at the expansion valve.

This is also supported by triglycerides generally having a lower melting point than their constituent fatty acids. In testing the Bluon TdX for behavior at 32° F. and even down to 14° F., the Bluon TdX flowed sluggishly, but did not freeze. This indicates the Bluon TdX and some other compositions of the inventive subject matter will not freeze in the evaporator unit of the air conditioner and will remain a liquid throughout the cycle. At high pressure, r-134a is a liquid, but evaporates from the oils at the expansion valve, R-134a will preferentially carry away much of the heat of the oils, allowing the oils to act as a secondary “assistant” refrigerant.

Another reason for the significant increase in refrigerant efficiency can be attributed to surface binding of the Bluon TdX, and other compositions of the inventive subject matter, to the metal of the refrigerant system. This is evident from the fact that when a unit was switched from Bluon TdX to r-410a, there was a temporary improvement in efficiency, most likely due to the Bluon TdX halo-alkene complexes closely binding to the internal surfaces of the cooling system, until it was removed by the various constituents of r-410a. A smaller amount of efficiency is also gained by this lubrication effect, due to the smoother flow of gas and oils through the system.

This surface binding feature is also apparently responsible for the observed reduced refrigerant composition leakage from the air conditioning units. Most air conditioning system components were designed to use the larger Freon 113 (C₂Cl₃F₃), until it was banned due to it possibly damaging the ozone layer. The significant leakage problems with r-410a or r-134a are due to their smaller molecular geometry than the Freon 113 they were designed to replace. The fluorine atoms of r-410a and r-134a are much smaller than the chlorine atoms of Freon 113. Air conditioning systems charged with r-410a typically leak around 20% of the coolant into the atmosphere annually, r-134a has a slightly lower leakage rate. This is why car air conditioners, almost exclusively use r-134a, and need to be recharged every few years. However, the leakage rate of r-134a is still significantly higher than the leakage rate of Bluon TdX and other compositions of the inventive subject matter.

The likely physical process by which this leakage is reduced, is through the larger halo-alkene complexes efficiently filling any small fissures between the seals. Thus, the Bluon TdX substantially seals the system utilizing it, and reduces the need to recharge the system. Moreover, a system can be charged with approximately 50% less Bluon TdX (or other compositions of the inventive subject matter) than the installed refrigerant, such as r-22 or r-410a. The oils would stick to the rubber and metals with even stronger Van der Waals interactions then they stick to each other. As these oil molecules are held together by significant Van der Waals forces, they would greatly reduce the passage of any Bluon TdX out of the air conditioning system. This high Van der Waals complexing potential is not applicable to the usual mineral oil lubricants used in standard r-22, r-410a or r-134a system.

The UN Montreal Protocols of 2009 call for phasing out various refrigerants. In 2013, the amount of some refrigerants produced is allegedly to be frozen. As compositions of the inventive subject matter can operate more efficiently and reduce leakage, they can help overcome these imposed production limitations. These complexes can help many nations achieve the goal of the Montreal Protocols faster.

Car manufacturers in Europe are reported to be in dire straits, since they are mandated to phase out r-134a in European cars, and they have no good alternatives. See “Refrigerants heat up in Europe” by Clay Boswell, found at http://chemical.ihs.com/IHS/Public/NewsEventsArt/PR_Articles/Feb08Refrigerants.pdf. Bluon TdX and other compositions of the inventive subject matter have the potential to help solve their problem from several angles. An important factor to achieve this is the inventive subject matter's (e.g., Bluon TdX's) ability to significantly reduce leakage in air conditioning systems. Most automobile air conditioning systems will have several recharges over their lifetimes and Direct Emissions can be up to 40% of their Total Equivalent Warming Impact (TEWI). An average quality automobile air conditioning system will lose around 12% of its refrigerant annually. From operating the test units using Bluon TdX, observed leakage is greatly reduced. If leakage could be reduced 90% by Bluon TdX, total TEWI in automobile air conditioning systems could be reduced by 35%.

Another more important factor is the increase in operating efficiencies of the air conditioning unit. The Indirect Emissions of automobile air conditioning units are around 60% of the total TEWI in temperate regions and much more in the tropics. We know from testing, around 35% to 60% the wattage is needed to run an air conditioning system on Bluon TdX. This would shave another 20% to 30+% off the TEWI. There is not much that can be done about the Transportation Effect of the TEWI. In total, around 55% to 65+% of TEWI could be shaved off the standard r-134a automobile air conditioning system, if they were converted to Bluon TdX or another composition of the inventive subject matter. This would reduce the TEWI of a Bluon TdX system below that of a CO₂ air conditioning system in most parts of the planet.

The amount of energy taken up by turning water vapor in the atmosphere into a liquid (enthalpy of condensation) is rather large, approximately 2.27 million J/kg (joules per kilogram). It is more than ten times more enthalpy than any refrigerant used inside a system. There is a large energy drain as moisture or ice reduces air interaction with the coils of a refrigeration system, making them even less efficient at removing heat from the air. A significant benefit of compositions of the inventive subject matter (e.g., Bluon TdX) is that it produces less than ⅓ of the condensation that standard air conditioning systems produce, thereby increasing a refrigeration system's efficiency and cooling efficacy.

It is contemplated that the ratio of one fatty acid to one heat transfer fluid can comprise any suitable ratio, including for example, 1:1000, 1:100, 1:10, 1:5 or even 100:1 or more. It is also contemplated that the ratio of one food oil (from which at least one fatty acid is derived) to another food oil, of a mixture (non-activated) or activated blend, can comprise any suitable ratio including for example, 1:1, 1:2, 1:3, 1:4, or even 1:100 or less. In some embodiments, a chemical marker can also be included.

As used herein, and unless the context dictates otherwise, the term “coupled to” is intended to include both direct coupling (in which two elements that are coupled to each other contact each other) and indirect coupling (in which at least one element is interposed between the two elements). Therefore, the terms “coupled to” and “coupled with” are used synonymously.

It should be noted that one having ordinary skill in the art should realize that all numbers herein are approximates, regardless or whether or not the numbers are preceded by the word “approximately”.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A composition comprising a polar heat transfer fluid at least partially complexed via Van der Waals forces with a plurality of fatty acid molecules of an activated oil blend, wherein the activated oil blend comprises:
a first organic oil;
a second organic oil; and
wherein each of the first and second organic oils were activated in a closed vessel under heat and pressure.

2. The composition of claim 1, wherein the plurality of fatty acid molecules comprises at least one oleic acid and at least one linoleic acid.

3. The composition of claim 1, wherein the composition comprises a polar heat transfer fluid to activated oil blend ratio of between 5:95 and 1:99 by weight percent.

4. The composition of claim 1, wherein the first organic oil comprises a walnut oil and the second organic oil comprises a canola oil.

5. The composition of claim 1, wherein the activated oil blend further comprises a third organic oil, and wherein the third organic oil comprises an almond oil.

6. The composition of claim 5, wherein the activated oil blend comprises a linoleic acid to oleic acid ratio of between 70:30 and 50:50.

7. The composition of claim 5, wherein the polar heat transfer fluid comprises r-134a molecules, chemically known as 1,1,1,2-tetrafluoroethane.

8. The composition of claim 1, wherein the first organic oil comprises canola oil and the second organic oil comprises sunflower oil.

9. The composition of claim 8, wherein the canola oil and the sunflower oil are present in a ratio of 3:1.

10. The composition of claim 1, wherein the first fatty acid comprises at least one of the plurality of fatty acid molecules comprises at least 14 carbons.

11. The composition of claim 1, wherein the composition comprises a polar heat transfer fluid to activated oil blend ratio of between 99:1 and 95:5 by weight percent.

12. The composition of claim 1, wherein at least one of the plurality of fatty acid molecules comprises at least two carbon-to-carbon double bonds.

13. The composition of claim 1, wherein the closed chamber comprises a copper catalyst.

14. The composition of claim 1, wherein the closed chamber comprises a Nylon catalyst.

15. The composition of claim 1, wherein the closed chamber comprises a stainless steel catalyst.

16. A composition comprising:
a first organic oil comprising oleic acid;
a second organic oil comprising linoleic acid; and
wherein the first organic oil and second organic oil are activated in a closed chamber via a copper catalyst.

17. The composition of claim 16, further comprising a polar heat transfer fluid complexed with at least some of the activated first organic oil.

18. The composition of claim 16, wherein the first organic oil and second organic oil are activated in a closed chamber via a copper catalyst under heat and pressure.

19. The composition of claim 17, wherein the activated first and second organic oils are configured to Van der Waals interact with a polar heat transfer fluid.
